(19) United States
(12) Patent Application Publication
(10) Pub. No.: US 2009/0013159 A1
(43) Pub. Date: Jan. 8, 2009

(54) Queue Processor And Data Processing Method By The Queue Processor

(75) Inventor: Masahiro Sowa, Kanagawa-ken (JP)

Correspondence Address: NDQ&M WATCHSTONE LLP, 1300 EYE STREET, NW, SUITE 1000 WEST TOWER, WASHINGTON, DC, 20005, US

(73) Assignee: THE UNIVERSITY OF ELECTRO-COMMUNICATIONS, Chofu-shi, Tokyo (JP)

(21) Appl. No.: 12/279,288

(22) PCT Filed: Feb. 9, 2007
(86) PCT No.: PCT/JP2007/052362

§ 371 Date: Aug. 13, 2008

(30) Foreign Application Priority Data
Feb. 14, 2006 (JP) 2006-037033

(51) Int. Cl. G06F 9/312; G06F 12/00

(52) U.S. Cl. 712/225; 711/154; 711/E12.001; 712/E09.033

(57) ABSTRACT

A queue processor and its data processing method are provided. It can do high-speed data processing and decreases the electric energy consumption.

The queue processor equips multiple operation data storing queues (18, 19) for storing the obtained memory stored data and intermediate result data during processing, and multiple execution units (17a, 17b, 17c) accessible to each of multiple operation data storing queues (18, 19), the execution unit (17a, 17b, 17c) doing the processing using memory stored data or intermediate result data obtained from any one of multiple operation data storing queues (18, 19), the execution units (17a, 17b, 17c) storing a calculated result in any one of multiple operation data storing queues (18, 19).

### TECHNICAL FIELD

A present invention relates to queue processor which use multiple queues or First In First Out memories as an intermediate result storing memory, and a data processing method in the queue processor.

### BACKGROUND ART

Conventionally, a processor mounted in a computer reads data stored in a main memory in the computer, then processes it.

The processor includes an intermediate result storing memory for storing intermediate result data of an operation in the inside, and an arithmetic unit. When executing operation processing using these, memory stored data which is the data stored in a main memory outside of a processor is copied to the intermediate result storing memory in the processor firstly, copied data are processed by the arithmetic unit, and the result is returned to the intermediate result storing memory. After repeating this processing several times, a calculated result in the intermediate result storing memory is returned to the main memory outside of the processor.

A processor using a RAM (Random Access Memory) as this intermediate result storing memory in which high-speed access is possible has spread widely. It is called a registers and their capacity is small.

However, since a use register must be specified with an operand of an instruction word if the register is used as the intermediate result storing memory, an instruction length becomes long. Therefore, there were problems that the process switching becomes slow or the program length becomes long.

Since communication by small digital equipment represented by a cellular phone prospered in particular in recent years, development of a small processor to which high-speed operation processing is possible and the energy is saved had been demanded.

As a processor for solving a problem of traffic, there is a processor which uses a stack for intermediate result storing memory. Since it is not necessary to designate an operand in an instruction word if using a stack for the intermediate result storing memory, the instruction length can be shortened. However, since the stack is an FILO (First In Last Out) method, and data recorded later is used, there was a problem that parallel processing for this high speed processing is difficult.

Then, in order to make the parallel processing possible, the present inventor developed a processor which used a queue with FIFO (First In First Out) method for the intermediate result storing memory.

The processor using a queue has the features that instructions executable simultaneously appear continuously that: parallel processing is possible and high performance is obtained because; the instruction length is short since operand designation is unnecessary in an instruction word; program length is short; hardware is small and power consumption is small; a clock frequency is high; and the like.

As technology about a processor using a queue, there are some described in the Patent Documents 1 and 2.

Patent Document 1: Japanese patent publication No. 3701583.

Patent Document 2: Japanese patent publication Laid-open No. 2005-293083.

A queue processor of the Patent Document 1 confirms whether or not data required for execution of an instruction is existed in a queue used as the intermediate result storing memory, and enables execution of parallel processing by sending all required data in the queue to an execution unit simultaneously.

This technology enables to accelerate the processor speed.

Moreover, when context switching occurs by interrupt treatment of an instruction, etc., the queue processor of the patent documents 2 can give configuration flexibility of a queue while being able to spill and return data for a program before switching, and can also be made to extend when data becomes full at the queue. With such technology, a queue processor can be used still more efficiently.

However, in the queue processor, since data is extracted by sequence stored, there is a problem that an program is not correctly executed if an sequence order (the sequence of production order) of data which is produced and stored by instruction is not agreement with an sequence order (the sequence of consumption order) of data extracted from stored data for an operation, and this is unsolvable with the technology of the above-mentioned Patent Documents 1 and 2.

In order to solve this problem, a queue processor of so called, a production sequence type queue computation model in which data stored in sequence of production is extracted in sequence of consumption is proposed by the Patent Document 3.

Patent Document 3: Japanese patent publication Laid-open No. 2004-246449.

However, there were the following problems in this production sequence type queue computation model.

(a) In order to access data in a queue which is not the queue head, an offset express section in an instruction word to show it is required, and many numbers of bits are needed to designate data separating from the queue head long. For example, as shown in FIG. 8, when subtracting data of the queue head QH and data separated by two word from queue head QH+1, an offset express section is required such as “+2” like an instruction “sub+2”.

(b) Since a queue is like a pipe, when there is a data in a head of the queue which is required later and there is also many unnecessary data after it, this unnecessary data cannot be thrown away. Therefore useless data must be stored. Therefore, the queue length must become long more than needed. Moreover, in order to access the data in the head, many numbers of bits are also needed for the offset express section of the instruction word.

(c) As shown in FIG. 9(a), in the processor, although a memory address modification register is installed as another of the intermediate result storing memory, in order to execute the memory access modification of FIG. 9(b) efficiently, many numbers of registers are required as a memory address modification register, at the same time it will be necessary to designate a memory address modification register when reading data stored in the data memory, and therefore the instruction length will become long.

For example, in order to access the 512^{nd} address data of data memory in FIG. 9 (b), it must be shown that value “500” stored in the register r5 of the memory address modification register must be obtained as an address for memory address modification by an instruction “Id r1, 12 (r5)”, and storing data at “512^{nd}” address which added “12” to this “500” is stored in the register r1.

Similarly, in order to access the 9012^{nd} address data in the data memory, it must be shown that value “9000” stored in the register r6 of the memory address modification register is obtained as an address for memory address modification by an instruction “Id r1, 12 (r6)”, storing data at “9012^{nd}” address which added “12” to this “9000” in the register r1.

Moreover, in a queue processor using a production sequence type queue computation model, there is technology which made it possible to take data in sequence of consumption order by providing a temporary queue to which data is spilled temporarily instead of an operation queue.

A structure of a processor 100 which provides this temporary queue is shown in FIG. 10.

In the processor 100 of FIG. 10, an instruction, which is fetched from an IM (Instruction Memory) 11 and is decoded in a DU (instruction Decoding Unit) 13, is executed in an EU (Execution Unit) 17 using data obtained from a DM (Data Memory) 22, and the data obtained by the execution is stored in an operation data storing queue 18 or a temporary queue 26 as an operation queue.

The EU (Execution Unit) 17 includes a first execution unit 17a and a second execution unit 17b accessible only to the operation queue 18, and a transfer unit 17x accessible to both the operation queue 18 and the temporary queue 26, and data temporarily stored in the temporary queue 26 is altogether transferred through the transfer unit 17x.

Thus, since it is possible to obtain the data in sequence of consumption order by providing both the operation queue 18 and the temporary queue 26, an instruction is executed correctly.

When there is unnecessary data following data which is needed later, it can be avoided by storing the necessary data in the temporary queue 26 temporarily that the useless data is stored and the queue length becomes long more than needed.

However, in the above-mentioned processor 100, since an instruction transferred to the transfer unit 17x is needed when accessing the temporary queue 26, the program length became long, and there was a problem which prevents improvement in the speed of execution of the processor.

The present invention achieves in light of the above-mentioned circumstances, and its object is to provide a queue processor to which high-speed operation processing is possible and the electric power is saved by simplifying a program and shortening an instruction length at the same time, and a data processing method by the queue processor.

### DISCLOSURE OF INVENTION

A queue processor according to claim 1 is a queue processor which obtains memory stored data stored in an data memory and executes operation by executing an instruction of a program, the queue processor characterized by comprising: multiple operation data storing queues for storing the obtained memory stored data and intermediate result data during operation processing with first-in, first-out; and multiple execution units accessible to each of the multiple operation data storing queues, the multiple execution units obtaining the memory stored data or the intermediate result data from any one of or two of the multiple operation data storing queues with first-in, first-out, and executing the operation processing, the multiple execution units sending out this calculated result in order to store in one of the multiple operation data storing queues with first-in, first-out.

A queue processor according to claim 2 is the queue processor according to claim 1, characterized in that the queue processor includes a memory addresses queue for being possible to store an address for memory address modification for accessing to the data memory, and to store the intermediate result data of the operation processing.

A queue processor according to claim 2 is the queue processor according to claim 1 or 2, characterized in that the queue processor includes a system information queue which can store system information about execution of the program, and can store the intermediate result data of the operation processing.

A queue processor according to claim 4 is a queue processor which obtains memory stored data stored in a data memory and executes operation by executing an instruction of a program, the queue processor characterized by comprising: a memory addresses queue which can store an address for memory address modification for accessing to the data memory, and can store intermediate result data of the operation.

A queue processor according to claim 5 is a queue processor which obtains memory stored data stored in a data memory and executes operation by executing an instruction of a program, the queue processor characterized by comprising: a system information queue which can store system information about execution of the program, and can store intermediate result data of the operation processing.

A data processing method in a queue processor according to claim 6 is a data processing method by a queue processor which obtains memory stored data stored in an external data memory and executes operation by executing an instruction of a program, the data processing method characterized by comprising: by an execution unit accessible to each of two or more operation data storing queues which store the obtained memory stored data and intermediate result data during operation processing with first-in, first-out, obtaining the memory stored data or the intermediate result data from any one of or two of the multiple operation data storing queues with first-in, first-out, and executing operation; and sending out this calculated result in order to store in one of the multiple operation data storing queues with first-in, first-out.

A data processing method in a queue processor according to claim 7 is the data processing method in the queue processor according to claim 6, characterized in that a memory addresses queue for storing an address for memory address modification is used when accessing to the data memory.

A data processing method in a queue processor according to claim 8 is the data processing method by the queue processor according to claim 6 or 7, characterized in that a system information queue for storing system information about execution of the program is used when executing the operation.

A data processing method by a processor according to claim 9 is a data processing method by a processor which obtains memory stored data stored in an external data memory and executes operation by executing an instruction of a program, the data processing method characterized by comprising: a memory addresses queue for storing an address for memory address modification is used when accessing to the data memory.

A data processing method by a processor according to claim 10 is a data processing method by a processor which obtains memory stored data stored in a data memory and executes operation by executing an instruction of a program, the data processing method characterized by comprising: a system information queue for storing system information about execution of the program is used when executing the operation processing.

### BRIEF DESCRIPTION OF THE DRAWINGS

FIG. 1 is a block diagram showing a structure of a queue processor according to a first embodiment of the present invention.

FIG. 2 is an explanatory diagram showing an operation in the case where data is produced, in an operation data storing queue of the queue processor according to the first embodiment of the present invention.

FIG. 3 is an explanatory diagram showing an operation in the case where data is consumed, in the operation data storing queue of the queue processor according to the first embodiment of the present invention.

FIG. 4 is a block diagram showing a structure of a queue processor according to a second embodiment of the present invention.

FIG. 5 is an explanatory diagram showing an operation when reading data stored in a data memory from the queue processor according to the second embodiment of the present invention.

FIG. 6 is an explanatory diagram showing an operation when reading data stored in the data memory from the queue processor according to the second embodiment of the present invention.

FIG. 7 is an explanatory diagram showing a system memory of the queue processor according to the second embodiment of the present invention.

FIG. 8 is an explanatory diagram showing an operation in the case where data is consumed, in an operation data storing queue of a queue processor which used the conventional production sequence type queue computation model.

FIG. 9 is an explanatory diagram showing an operation when reading data stored in a data memory from a conventional processor.

FIG. 10 is a block diagram showing a structure of a conventional queue processor.

FIG. 11 is an explanatory diagram showing data flow when an instruction hole problem occurs by execution of a program, in the queue processor which used the conventional production consumption sequence type queue computation model.

FIG. 12 is an explanatory diagram showing a transition state of data in a queue when the instruction hole problem occurs by execution of the program, in the queue processor which used the conventional production consumption sequence type queue computation model.

FIG. 13 is an explanatory diagram showing data flow when a cross arc problem occurs by execution of a program, in the queue processor which used the conventional production consumption sequence type queue computation model.

FIG. 14 is an explanatory diagram showing a transition state of data in a queue when the cross arc problem occurs by execution of the program, in the queue processor which used the conventional production consumption sequence type queue computation model.

FIG. 15 is an explanatory diagram showing data flow when an equivalent data production problem occurs by execution of the program, in the queue processor which used the conventional production consumption sequence type queue computation model.

### BEST MODE FOR CARRYING OUT THE INVENTION

Hereinafter, although the embodiments of the present invention will be described, these embodiments are the things for explanation of the present invention absolutely, and do not limit the scope of the present invention. Therefore, although the person skilled in the art can adopt various kinds of embodiments including each of these elements or all the elements, these embodiments are also included in the scope of the present invention.

A basic principle of a queue processor which uses a queue for an intermediate result storing memory of a program will be explained.

### Basic Principle

### (1) Calculation Method of Queue Processor

In a processor, if a process which takes data from an intermediate result storing memory is defined as consumption, and a process which stores a calculated result in the intermediate result storing memory is defined as production, a computation model using a queue processor will be categorized into the following three from a relation among instructions.

1) Production Consumption sequence Type Queue Computation Model

It is a method that a sequence of storing intermediate result data in a queue agrees with a sequence produced and a sequence consumed. That is, it is a method that order of data in a queue agrees with the sequence of production of data and the sequence of consumption of data.

2) Consumption Sequence Type Queue Computation Model

It is a method which data is stored according to a consumption sequence when intermediate result data is stored in a queue. That is, it is a method that the order of data in a queue agrees with the sequence of consumption of data.

3) Production Sequence Type Queue Computation Model

It is a method which data is stored according to a produced sequence when intermediate result data is stored in a queue, and the data is taken according to a consumption sequence regardless of storing sequence when consuming. That is, it is a method that the order of data in a queue agrees with the sequence of production of data.

### (2) Problem of the Production Consumption Sequence Type Queue Computation Model

In the production consumption sequence type queue computation model, if a sequence (the production sequence) of data which is produced and stored by an instruction do not agree a sequence (the consumption sequence) of data taken for an operation, an instruction is not executed correctly.

Therefore, in the production consumption sequence type queue computation model, three problems, called (i) instruction hole problem, (ii) cross arc problem, and (iii) equivalent data production problem, occur. These problems will be explained.

### (i) Instruction Hole Problem

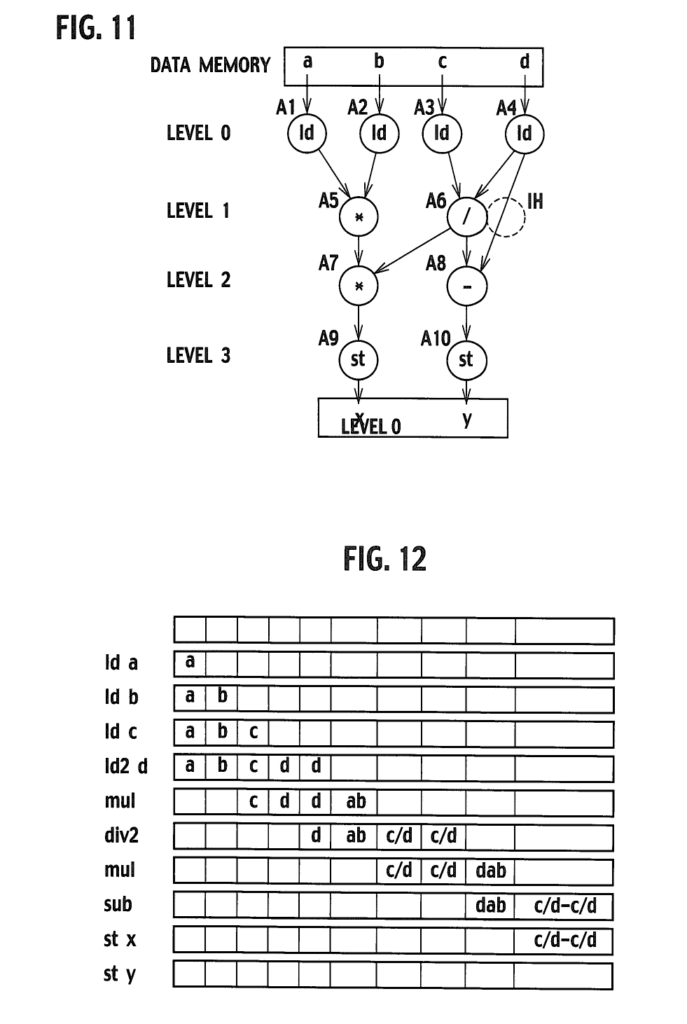

An instruction hole problem occurred in the production consumption sequence type queue computation model will be explained by using FIG. 11 and FIG. 12.

FIG. 11 is an explanatory diagram showing data flow by execution of a program for calculating x=“ab*c/d” and y=“c/d−d” using data “a”, “b”, “c”, and “d”.

In FIG. 11, “Id” denotes a loading instruction for reading data from a data memory into a queue, “*” denotes multiplication, “/” denotes division process, “−” denotes subtraction, and “st” denotes a store instruction for storing data of the queue in the memory.

Each instruction is executed in sequence of an instruction A1→an instruction A2→an instruction A3 . . . →an instruction A9→an instruction A10, and the instructions A1 to A4 are in the level 0, and the instructions A5 and A6 are in level 1, the instructions A7 and A8 are in the level 2 and the instructions A9 and A10 are in the levels 3 according to the contents of executions. Moreover, each arrow shows data flow.

As shown in FIG. 11: the data “a”, “b”, “c”, and “d”, which are memory stored data stored in the memory, are read (loaded) by the ld instructions A1, A2, A3, and A4, respectively; the data “a” loaded by the instruction A1 and the data “b” loaded by the instruction A2 are multiplied by instruction A5, and therefore data “ab” is calculated; the data “c” loaded by the instruction A3 and the data “d” loaded by the instruction A4 is executed by the division instruction A6, and therefore data “c/d” is calculated; the data “ab” calculated in the instruction A5 and the data “c/d” calculated in the instruction A6 are multiplied by the instruction A7, and therefore data “ab(c/d)” is calculated; the data “d” loaded in the instruction A4 is subtracted from “c/d” calculated in the instruction A6, and therefore data “c/d−d” is calculated; the data “ab(c/d)” calculated in the instruction A7 is stored in x of the memory in the instruction A9; and the data “c/d−d” calculated in the instruction A8 is stored in y of the memory in the instruction A10.

However, when this program is executed in the production consumption sequence type queue computation model, since the arc is drawn over one or more levels, such as the arc between the instruction A4 and the instruction A8, the program is not executed correctly.

A transition diagram of the data in the queue when the program of FIG. 11 is executed by the production consumption sequence type queue computation model is shown in FIG. 12.

In FIG. 12, left-hand side is the instructions to be executed, and right-hand side is a transition diagram showing a stored data in the queue.

In the contents of the instruction of this FIG. 12, the instruction “ld a” is an instruction for reading (loading) data at a^{th} address of the memory into the queue, the instruction “ld2 d” is an instruction for loading two data at d^{th} address of the memory, the instructions “mul”, “div”, and “sub” are instructions denoting multiplication, division process, and subtraction, respectively, the instruction “div2” is an instruction whose number of output data is two pieces as a result of the division process, and the instruction “st x” is an instruction for storing data in x^{th} address of the memory.

If the data produced or consumed by one instruction is shown within {}. In the case of FIG. 12, production sequence of the data is a, b, c, {d, d}, ab, and {c/d, c/d} . . . . Consumption sequence is {a, b}, {c, d}, {ab, c/d}, and {c/d, d} . . . . From this, we can see the mismatch of sequences between the production and consumption data.

As a result, although the calculation result should be x=ab(c/d) and y=cd−d, it becomes the wrong calculation result for x=dab and y=c/d−c/d. This is because an instruction is lacked at a place shown with IH of FIG. 11, this IH is called the instruction hole, and this problem is called the instruction hole problem.

### (ii) Cross Arc Problem

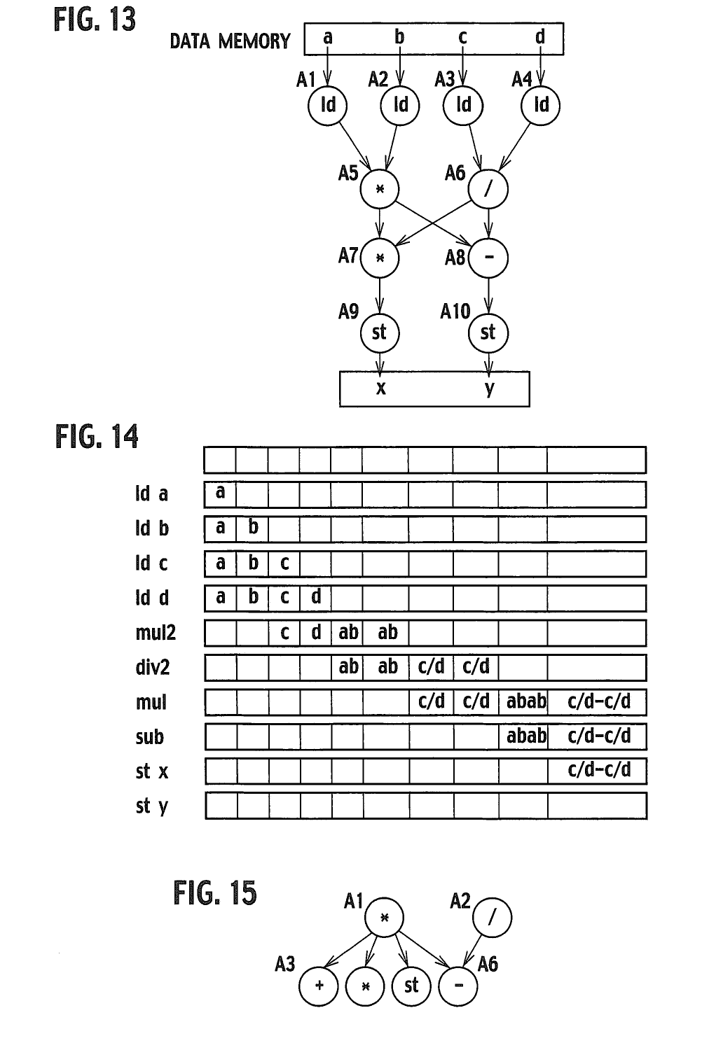

A cross arc problem occurred in the production consumption sequence type queue computation model will be explained by using FIG. 13 and FIG. 14.

In case there are arcs crossing each other, such as an arc of A5, A6 to A7, A8 of FIG. 13, the program which is executed by using the queue processor is not executed correctly.

A transition state of data in the queue when the program of FIG. 13 is executed on the production consumption sequence type queue computation model is shown in FIG. 14.

In this FIG. 14, although the production sequence of data is a, b, c, d, {ab, ab}, and {c/d, c/d} . . . , the consumption sequence is {a, b}, {c, d}, {ab, c/d}, and {ab, c/d} . . . , and therefore sequence relation of production and consumption of data is not match because of the crossing arcs.

As a result, although the calculation result should be x=ab(c/d) and y=ab·c/d, they become wrong result, x=abab and y=c/d·c/d. This problem is called the cross arc problem.

(iii) Equivalent Data Production Problem

In the production consumption sequence type queue computation model, once data is used, it will disappear. Therefore, only the needed number must be produced even if it is data of the same value.

If many data is produced by one instruction such as the instruction A1 of FIG. 15, the instruction length will become large and the execution time will also become long. This problem is called the equivalent data production problem.

### First Embodiment

A queue processor according to the first embodiment of the present invention can solve all the (i) instruction hole problem, (ii) cross arc problem, and (iii) equivalent data production problem in the computation model explained in the basic principle.

### Structure of Queue Processor according to the First Embodiment

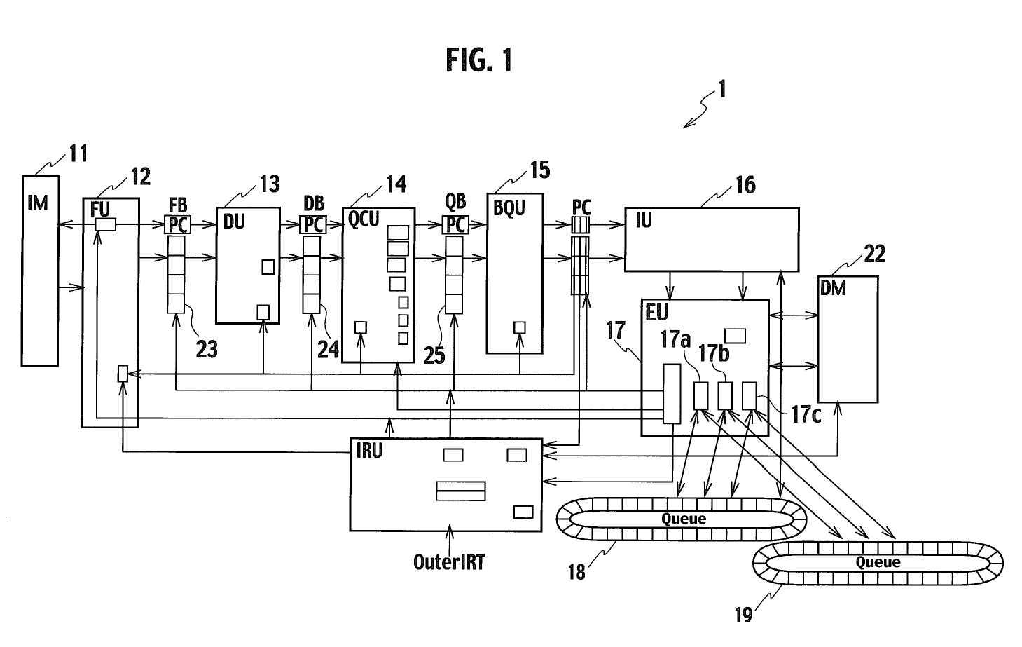

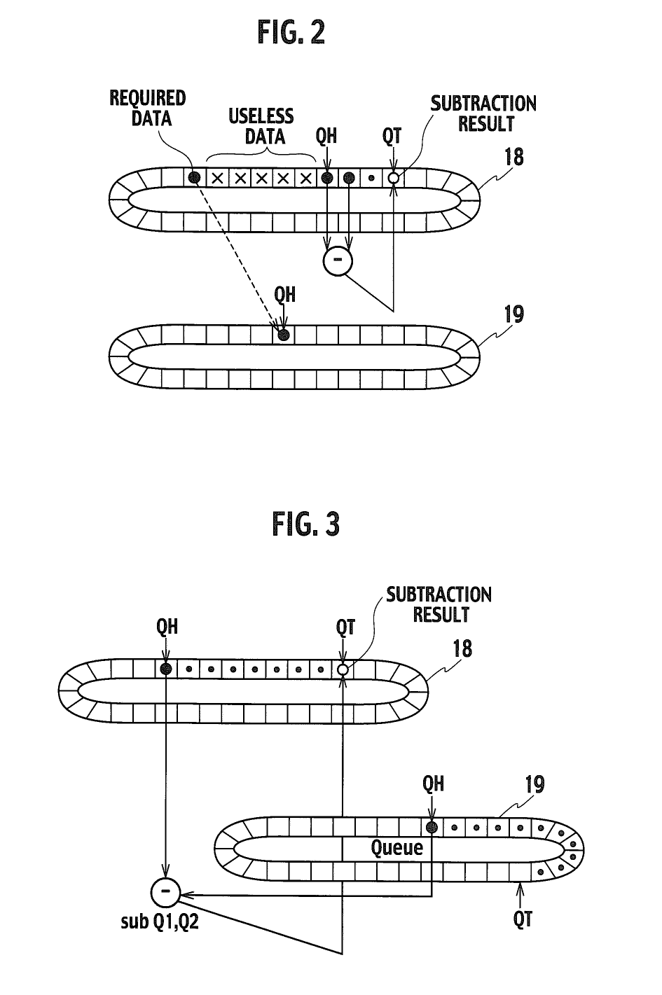

A structure of a queue processor 1 according to this embodiment will be explained using FIG. 1.

The queue processor 1 according to this embodiment includes an FU (Fetch Unit) 12, a DU (instruction Decoding Unit) 13, a QCU (Queue Calculating Unit) 14, a BQU (Barrier Queue control Unit) 15, an IU (Issuing Unit) 16, an EU (Execution Unit) 17, a first operation data storing queue 18, a second operation data storing queue 19, an FB (Fetch Buffer) 23, a DB (Decoding Buffer) 24, and a QB (Queue calculation Buffer) 25. Moreover, an external memory (main memory) composes an IM (Instruction Memory) 11 and a DM (Data Memory) 22.

The instruction memory 11 stores an instruction for executing a program.

The fetch unit 12 fetches an instruction group from the instruction memory 11.

The instruction decoding unit 13 divides the instruction group into each instruction.

The queue calculating unit 14 calculates a queue head QH value and a queue tail QT value when the instruction is executed.

The barrier queue control unit 15 processes an instruction of barrier related, and controls a circulation queue.

The issuing unit 16 finds an executable instruction group, and sends it out to the execution unit 17.

The execution unit 17 includes a first execution unit 17a, a second execution unit 17b, and a third execution unit 17c, and its each is accessible to both the first operation data storing queue 18 and the second operation data storing queue. These first execution unit 17a, second execution unit 17b, and third execution unit 17c have the same function.

The first operation data storing queue 18 and the second operation data storing queue 19 are an intermediate result storing memory for storing data used for an operation.

The data memory 22 stores the data used for the operation.

The fetch buffer 23, the decoding buffer 24, and the queue calculation buffer 25 are buffers for executing pipeline processing.

### Operation of Queue Processor according to the First Embodiment

An operation of the queue processor 1 according to this embodiment will be explained.

First of all, when execution of a program is started, an instruction group which composes multiple instructions is fetched from the instruction memory 11 by the fetch unit 12.

The fetched instruction group is divided into each instruction and is decoded in the instruction decoding unit 13, and further a queue head QH value and a queue tail QT value are calculated when the instruction is serially executed in the queue calculating unit 14.

Next, in the barrier queue control unit 15, overflow of the queue and the process of the barrier related instruction are processed.

Next, the instructions are divided into a memory access instruction and an arithmetic instruction in the issuing unit 16, and executable instructions are sent out to the execution unit 17.

Next, in any one of the first execution unit 17a of the execution unit 17, the second execution unit 17b or the third execution unit 17c, needed data is fetched from the data memory 22 by a memory access instruction of the obtained instruction group.

Next, the obtained data is used and an arithmetic instruction is executed in any one of the first execution unit 17a, the second execution unit 17b or the third execution unit 17c of the execution unit 17.

The intermediate result data obtained by the execution is stored in any one of the first operation data storing queue 18 or the second operation data storing queue 19 from any one of the first execution unit 17a, the second execution unit 17b or the third execution unit 17c.

At this point, we will explain a storing process of the intermediate result data when the first operation data storing queue 18 is used for storing the main operation data and the second operation data storing queue 19 is used for storing required data which uses by a next operation.

FIG. 3 shows the case where an instruction “sub Q1, Q2, Q1” is executed, the data obtained from the queue head QH of the second operation data storing queue 19 subtracts from the data obtained from the queue head QH of the first operation data storing queue 18, and then the calculated result is stored in the queue tail QT of the first operation data storing queue 18.

Since two queues are used for storing the operation data according to the above first embodiment, one queue can be use for storing temporarily the data used for a later instruction, and therefore the cross arc problem, the instruction hole instruction, and the equivalent data production problem can be solved.

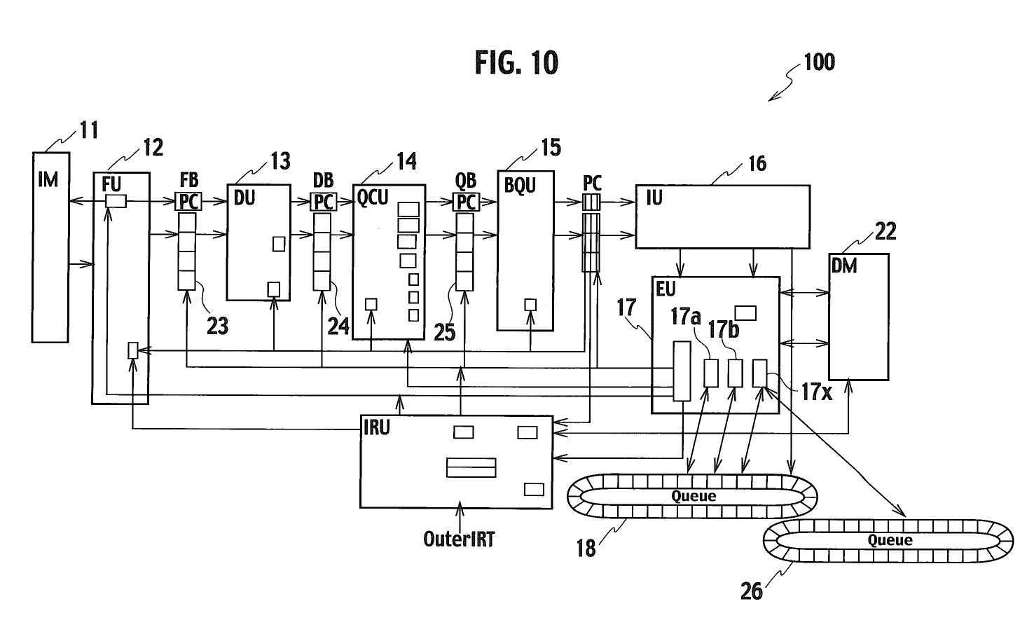

Since each of the first execution unit 17a, the second execution unit 17b, and the third execution unit 17c is accessible to both the first operation data storing queue 18 and the second operation data storing queue 19, and it is possible to describe an operation instruction and a queue to access by one instruction when accessing, the offset is unnecessary, and since an instruction transferred to the transfer unit 17x executed by the conventional queue processor shown in FIG. 10 is also unnecessary, the program length can be shortened.

Moreover, it is possible to take multiple data in and out by these multiple execution units, therefore the execution speed of the program can be increased.

In this embodiment, although explained using two operation data storing queues, it is possible for it not to be limited to this and also to increase the number of queues.

### Second Embodiment

A queue processor by a second embodiment of the present invention uses a queue for memory addresses instead of the memory address modification register. And we also use the first operation data storing queue, the second operation data storing queue, and uses the queue as a memory which stores system information.

### Structure of Queue Processor according to the Second Embodiment

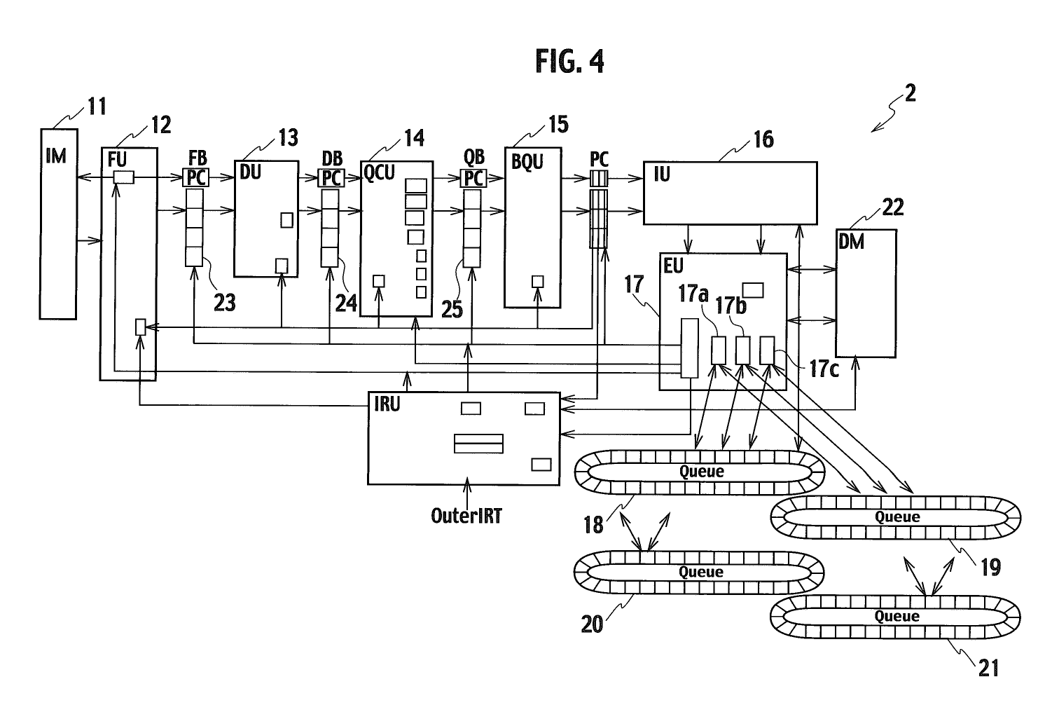

A structure of the queue processor 2 according to this embodiment will be explained using FIG. 4.

Since the queue processor 2 according to this embodiment is the same as the first embodiment except having a memory addresses queue 20 and a system information queue 21, detailed explanation is omitted.

The memory addresses queue 20 stores an address used as an index to modify memory address.

The system information queue 21 includes a return value address, a stack pointer, a frame pointer, an interrupt vector table pointer, PC at the time of an exception, and an absolute address for storing system information of the program status word 0 to 3 etc., and is actually used by the same method as a register.

### Operation of Queue Processor according to the Second Embodiment

An operation of the queue processor 1 according to this embodiment will be explained.

In this embodiment, since a process executed with the instruction memory 11 to the issuing unit 16 is the same as the first embodiment, detailed explanation is omitted.

If a memory access instruction is obtained in the execution unit 17, access is executed to the data memory 22 based on this memory access instruction.

The memory access instruction consists of a function part, a memory address part, and an address part for modification. The memory addresses queue 20 for storing an address used as an index for the memory address modification is designated from multiple queues by this address part.

In this embodiment, since four pieces, the first operation data storing queue 18, the second operation data storing queue 19, the memory addresses queue 20, and the system information queue 21, are used as the queues, 2 bits is enough to identify these.

Therefore, a memory access instruction consist of 8 bits for the function part, 2 bits for the memory address part and 16 bits for the address part for modification, and therefore the instruction length becomes 26 bits.

The data is obtained from the data memory 22 by executing the memory access instruction composed in this way in the execution unit 17.

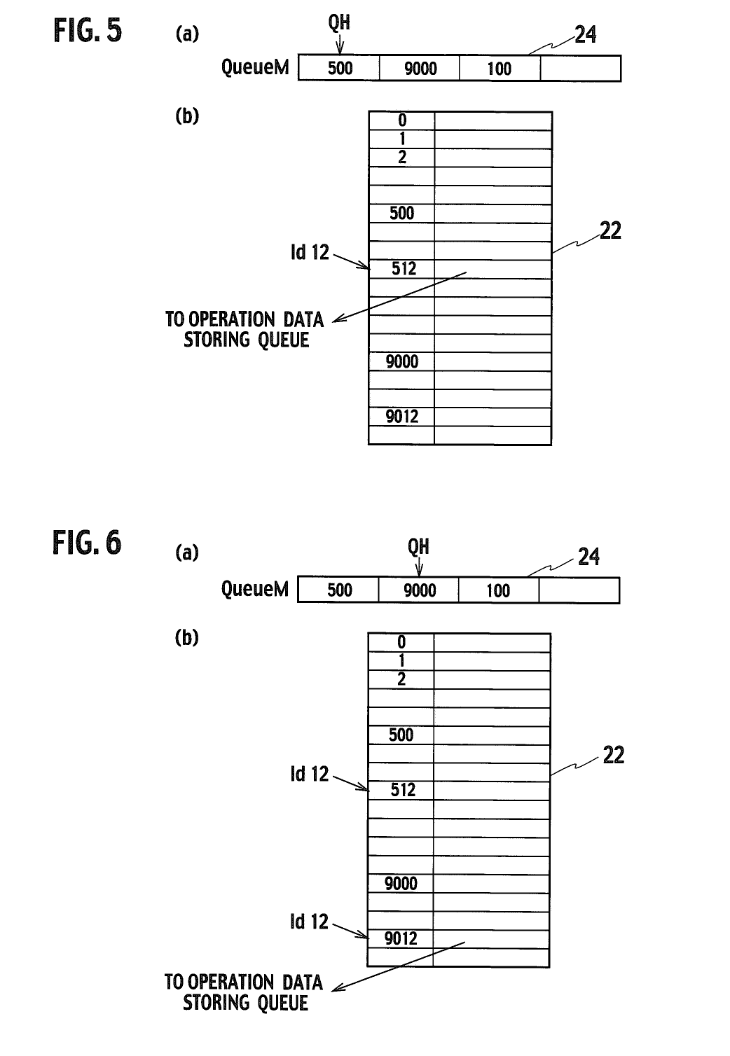

In this embodiment, we will explain the method to fetch data from the data memory 22 by the memory access instruction by using FIG. 5 and FIG. 6.

In FIG. 5 and FIG. 6, (a) denotes the memory addresses queue 20 and (b) denotes the data memory 22.

In case of accessing the 512^{nd} address of the data memory 22, “ld 12” can access the address because memory address modification value “500” is obtained from a position of the queue head QH as shown in FIG. 5(a).

Moreover, In case of accessing the 9012^{nd} address of the data memory 22, “ld 12” can access the address because memory address modification value “9000” is obtained from a position of the queue head QH as shown in FIG. 6(a).

As shown in FIG. 5(b) or FIG. 6(b), the data obtained from the data memory 22 is stored in any one of the first operation data storing queue 18 or the second operation data storing queue 19.

Next, an instruction is executed using any one of the first operation data storing queue 18 or the second operation data storing queue 19.

Since it is the same as the first embodiment about the execution of the arithmetic instruction, detailed explanation is omitted.

Moreover, an empty queue word of the memory addresses queue 20 can also be used for storing an intermediate result of operation data.

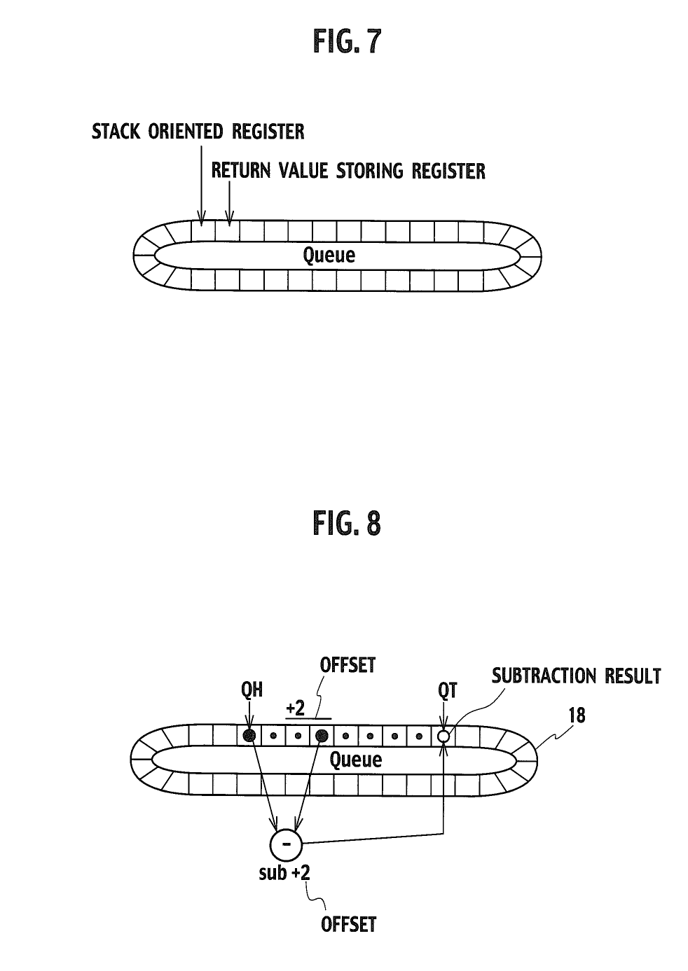

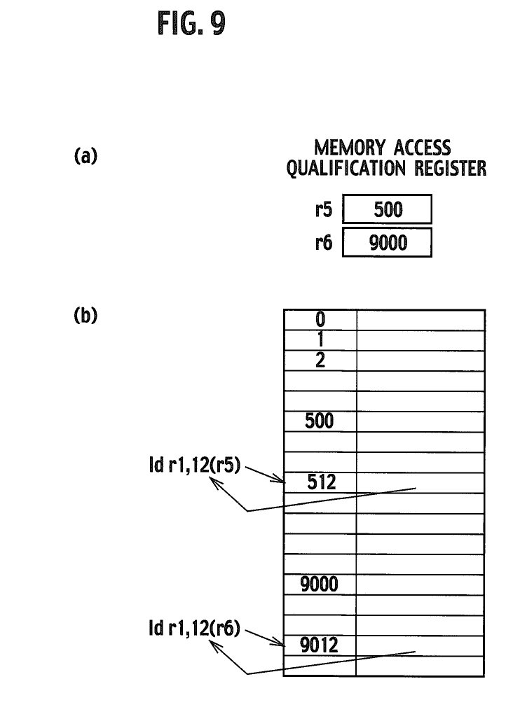

Moreover, as shown in FIG. 7, although the system information queue 21 stores the system information, such as a stack register and a return value address, as an absolute address, and is used by the same method as a register if needed, it is also possible to use an empty queue word as a random access register for storing an intermediate result data.

According to an above-mentioned second embodiment, since the memory addresses queue is used for storing the address for memory address modification, the memory access instruction designates this memory address queue for memory address modification. Therefore the offset becomes unnecessary.

Therefore, although the instruction has composed from 29 bits (the function part is 8 bits, the memory address part is 16 bits, and the register part for modification is 5 bits) when a register is used for memory address modification, in contrast, it can compose from 26 bits and the instruction length can be shortened according to this embodiment.

Moreover, the structure of the processor becomes simple by using the queue for storing operation data, memory addresses, and system information. And since it is also possible to use the memory addresses queue and the system information queue for storing operation data, the performance improvement can be achieved.

Moreover, these queues can also be stored and read in random access method.

According to the queue processor and the data processing method by the queue processor of the present invention, it can shorten the instruction length of the instruction and can make high-speed operation possible by using multiple queues instead of the conventional registers, and the structure of the processor can be simplified and electric energy consumption can be decreased.

1. In a queue processor which obtains memory stored data stored in a data memory outside of the processor and executes operation by executing an instruction of a program, the queue processor characterized by comprising:
multiple operation data storing queues for storing the obtained memory stored data and intermediate result data during processing in first-in, first-out manner; and
multiple execution units accessible to each of two or more of said operation data storing queues, the multiple execution units obtaining said memory stored data or said intermediate result data from any one of or two of said multiple operation data storing queues in first-in, first-out manner, and executing the operation processing, the multiple execution units sending out this calculated result in order to store in one of said multiple operation data storing queues in first-in, first-out manner.

2. The queue processor according to claim 1, characterized in that
the queue processor includes a memory addresses queue for being possible to store an address for memory address modification for accessing to said data memory, and to store the intermediate result data of said operation processing.

3. The queue processor according to claim 1 or 2, characterized in that
the queue processor includes a system information queue which can store system information about execution of the program, and can store the intermediate result data.

4. A queue processor which obtains memory stored data stored in a data memory outside of the processor and does processing by executing an instruction of a program, the queue processor characterized by comprising:
a memory addresses queue which can store an address for memory address modification for accessing to said data memory, and can store intermediate result data.

5. A queue processor which obtains memory stored data stored in a data memory outside of the processor and does processing by executing an instruction of a program, the queue processor characterized by comprising:
a system information queue which can store system information about execution of the program, and can store intermediate result data of said operation processing.

6. A data processing method by a queue processor which obtains memory stored data stored in an data memory outside of the processor and does processing by executing an instruction of a program, the data processing method characterized by comprising:
by an execution unit accessible to each of multiple operation data storing queues which store the obtained memory stored data and intermediate result data during operation processing in first-in, first-out manner,
obtaining said memory stored data or said intermediate result data from any one of or two of said multiple operation data storing queues in first-in, first-out manner, and doing processing; and
sending out this calculated result in order to store in one of said multiple operation data storing queues in first-in, first-out manner.

7. The data processing method by the queue processor according to claim 6, characterized in that
a memory addresses queue for storing an address for memory address modification is used when accessing to said data memory.

8. The data processing method by the queue processor according to claim 6 or 7, characterized in that
a system information queue for storing system information for execution of the program is used when doing said processing.

9. A data processing method by a processor which obtains memory stored data stored in an external data memory and does processing by executing an instruction of a program, the data processing method characterized by comprising:
a memory addresses queue for storing an address for memory address modification is used when accessing to said data memory.

10. A data processing method by a processor which obtains memory stored data stored in a data memory outside of the processor and does processing by executing an instruction of a program, the data processing method characterized by comprising:
a system information queue for storing system information about execution of the program is used when doing said processing.
